(19) United States
(12) Patent Application Publication
(10) Pub. No.: US 2023/0132031 A1
(43) Pub. Date: Apr. 27, 2023

(54) NEUTRON ABSORBING EMBEDDED HYDRIDE SHIELD

(71) Applicant: THE RESEARCH FOUNDATION FOR THE STATE UNIVERSITY OF NEW YORK, Albany, NY (US)

(72) Inventors: Lance Snead, Stony Brook, NY (US); Jason Trelewicz, Miller Place, NY (US)

(73) Assignee: THE RESEARCH FOUNDATION FOR THE STATE UNIVERSITY OF NEW YORK, Albany, NY (US)

(21) Appl. No.: 17/914,019

(22) PCT Filed: Mar. 23, 2021
(86) PCT No.: PCT/US21/23676

§ 371 Date: Sep. 23, 2022

Related U.S. Application Data
(60) Provisional application No. 62/993,309, filed on Mar. 23, 2020.

(51) Int. Cl. G21C 11/02; C04B 35/053; G21F 1/08; G21C 5/02; G21C 5/12

(52) U.S. Cl. CPC G21C 11/02; C04B 35/053; G21F 1/08; G21C 5/02; G21C 5/12; C04B 2235/3206; C04B 2235/44; C04B 2235/77; B22F 3/12

(57) ABSTRACT

A composite structure is disclosed comprising a neutron-absorbing metal hydride phase contained within a matrix having a density of greater than 95%. In various embodiments the metal hydride is a hydride of one or more of the following: Gadolinium, Hafnium, Europium, Samarium. The composite structure is utile as a shield for fusion or fission reactors.

### CROSS REFERENCE TO RELATED APPLICATION

This application claims priority under 35 U.S.C. § 119 to provisional application U.S. Ser. No. 62/993,309 filed Mar. 23, 2020, the entire contents of which are incorporated herein by reference for all purposes.

### GOVERNMENT SUPPORT

This invention was made with Government support under DE-AR0000977 awarded by the Department of Energy ARPA-E and under DE-SC0018332 awarded by the Department of Energy. The government has certain rights in the invention.

### FIELD

The present disclosure relates to solid multicomponent materials (i.e. composite structures), and the formation of same, engineered for the purpose of nuclear reactor shielding, including the simultaneous mitigation of combined x-ray and neutron irradiation. Applications include, without limitation, fusion reactor core internals or other nuclear systems where the need for simultaneous neutron and gamma radiation abatement is required. Invented structures are distinguished through independent function of composite constituents and formation methodology of final product.

### BACKGROUND

Ionizing radiation emanating from or contained within nuclear systems is often managed through the use of shielding to limit absorbed dose to workers and/or system components. While essentially any material has some effectiveness as a shield material, the selection or engineering of a highly effective shield, whether solid or liquid, flowing, permanent or replaceable, is dependent on the radiation type(s) being managed. For this reason, different and varied approaches are taken for nuclear system shielding.

The two primary forms of ionizing radiation of concern from a shielding perspective in fission power and fusion power systems are energetic neutrons and electromagnetic radiation (gamma rays.) In the central core and core-surrounds of both fission and fusion power systems these radiation forms are an inseparable threat. Functionally and practically these forms of radiation are mitigated in different ways. As an example, gamma irradiation is typically shielded through placement and interaction with very high-density materials. In these instances, the electromagnetic radiation primarily interacts with the high density of electrons in the heavy material depositing its energy through a number of channels such as electron excitation, Compton scattering, or pair production. To first order, the effectiveness of gamma ray shielding increases in direct proportion to material density, explaining the popularity of materials such as lead for gamma-ray shielding. In certain special applications, depleted uranium, thorium, and tungsten are also used, as are a range of specialty (relatively low cost) concrete mixtures with heavy aggregates, such as Baryte or Magnetite, to enhance density. However, even this high-density concrete (˜3.5 g/cc) would need to be many times thicker than lead (11.35 g/cc) to achieve an equivalent shielding effectiveness.

As neutrons are electrically neutral, they undergo only weak interaction as they pass through matter. With a mass similar to that of protons, the primary reaction of neutrons with material are elastic, or billiard-ball-type collisions, in which some fraction of their energy is lost in every collision. This reaction is referred to as an elastic scattering reaction for which the maximum energy per collision is lost when the neutron collides with material atoms of similar weight, the most similar being hydrogen, and the least similar being those of (high atomic mass) highly dense materials. For this reason, the metrics for selecting optimal shield materials for combined X-ray and neutron radiation are in direct opposition, with very light (hydrogenous) materials such as water being ideal for neutrons, and very heavy materials such as lead being ideal for X-rays.

There are numerous ways to judge and compare the effectiveness of shielding, including resulting heat deposition, nuclear damage, or through comparing equivalent thickness of a material required to reduce ionizing dose levels (i.e. X-ray dose) by half. As example, the normalized X-ray half-value-layer of normal concrete would be 44.5 mm, steel 12.7 mm, lead 4.8 mm, tungsten 3.3 mm, and uranium 2.8 mm.

The neutrons emanating from fusion and fission reactions are borne at different, but very high energies: 14.1 million electron volts (MeV) and approximately 2 MeV, respectively. As these neutrons pass through matter, they can interact in an elastic scatter or “billiard-ball” reaction and slowly lose energy. However, as they slow down within the material a second atomic reaction becomes increasingly important. Specifically, a material-dependent neutron capture reaction may occur whose by-product may be either stable or unstable (radioactive), and in some cases may immediately release one or more neutrons. In the event no secondary neutron is emitted the neutron is effectively shielded.

The probability of a neutron having an elastic scattering reaction as it passes through a material is defined by a parameter known as the elastic scattering cross section. This scattering process favors materials of high atomic number density and low atomic mass such as water, concrete, beryllium, and hydrocarbons as example. The probability of a neutron being absorbed as it interacts with the material, otherwise known as the neutron absorption cross section, is also a material dependent phenomenon and a strong function of the energy (velocity) of the incident neutron, with a complex dependency on the nuclear structure with different elements and isotopes of elements having vastly different absorption cross sections. As example, hydrogen and iron, two commonly used nuclear materials, have low-energy neutron absorption cross-sections of 0.2 and 3 barns, respectively. However, materials such as hafnium, boron, and europium have average neutron absorption cross sections of 104, 200, and 4530 barns, respectively. Within a specific element the isotopic absorption cross-sectional dependency can be dramatic. As example, the respective isotopic low neutron energy absorption cross-sections for gadolinium are 735 b for ¹⁵²Gd, 85 b for ¹⁵⁴Gd, 61100 b for ¹⁵⁵Gd, 1.5 b for ¹⁵⁶Gd, 259000b for ¹⁵⁷Gd, 2.2 b for ¹⁵⁸Gd, and 1 b for ¹⁶⁰Gd.

Biological and internal functional shielding is currently and widely used in both fission and fusion systems. Within fusion systems, one important function of shielding is to provide adequate suppression of both neutron and gamma flux emanating from the plasma core such that the superconducting magnets and their constituents are not overheated or succumb to physical damage. The most commonly investigated configuration of fusion device, the so-called Tokamak, is geometrically a toroid, with the radiation-generating plasma held within the torus. Tokamak shielding must mitigate threats to the superconducting coils: neutron cascade damage, heat deposition, and organic insulator damage due to x-rays and neutrons emanating from the toroid into the Tokamak structure. Current shield solutions use combinations of high atomic number, low atomic number, and highly absorbing absorber materials such as tungsten, water, and boron. Boronated steel cooled by water is a common example of a material used as shielding for both fusion and fission systems.

With significant improvement in High Temperature Superconductors (HTS), a number of projects are adopting HTS technology for power systems. Compact HTS Tokamaks offer advantages including lower plant costs, enhanced plasma control, and ultimately lower cost of electricity. As compact reactors, by definition, have less radiation space for shielding (especially on the inboard of the toroid), HTS degradation is a significant and potentially design limiting issue for compact HTS tokamaks Moreover, the use of water or bulk metal hydrides, two materials which enable the slowing down of neutrons as a prelude to neutron absorption and mitigation, are considered unattractive for next generation systems for economic and safety reasons. Thus, there is a need for improved materials that can be used as shields.

### SUMMARY

The present disclosure is directed to a multi-component composite that can be used as a shield for nuclear radiation, including one that can simultaneously shield gamma rays while moderating and absorbing neutrons. In comparison to shields known heretofore, the disclosed shield structures can be specifically engineered for intermediate and high-temperature nuclear environments with the aim of providing a compact lifetime component. In one instance, this is achieved through separating structural and shielding functions of the composite and further separating the gamma and neutron shielding functions to build a single, advanced composite shield. In one aspect, the composite structure of the disclosure combines constituents of substantially different processing windows through the advanced manufacturing process of direct current sintering and control of processing environment.

Without limitation, two composite components are provided for use in two relative operating temperature regimes of a nuclear system: a metal matrix composite for low-to-intermediate temperature application, and a ceramic matrix composite for intermediate-to-high temperature application. In one practice, a combination of structural matrix is used with an entrained metal hydride, whereby the metal hydride contains a highly neutron absorbing metal and a high density of hydrogen to serve as an effective neutron moderator. The combination of the metal in the metal hydride, and the metal of the matrix, serve to attenuate gamma irradiation.

The composite of the disclosure is tunable, in composition, to optimally match the required neutron moderation and absorption radially through the shield in order to achieve the desired goal of component damage and nuclear heating for a minimized form factor.

In one embodiment, the disclosure provides a shield for nuclear radiation comprising a composite structure comprising a metal hydride-entrained phase contained within a magnesium oxide-containing matrix having a density of greater than 95%, wherein the metal of the metal hydride-containing phase is selected from europium, gadolinium, samarium, or hafnium is provided.

In another embodiment, the disclosure provides a shield for nuclear radiation comprising a composite structure comprising a metal hydride-entrained phase contained within a nickel alloy-containing matrix having a density of greater than 95%, wherein the metal of the metal hydride-containing phase is selected from europium, gadolinium, samarium, or hafnium is provided.

In a further embodiment, the disclosure provides a shield for nuclear radiation comprising a composite structure comprising a metal hydride-entrained phase contained within a titanium alloy-containing matrix having a density of greater than 95%, wherein the metal of the metal hydride-containing phase is selected from europium, gadolinium, samarium, or hafnium is provided.

In a yet a further embodiment, the disclosure provides a shield for nuclear radiation comprising a composite structure including a metal hydride-entrained phase contained within a zirconium alloy-containing matrix having a density of greater than 95%, wherein the metal of the metal hydride-containing phase is selected from europium, gadolinium, samarium, or hafnium is provided.

In another embodiment, the disclosure provides a composite structure comprising a neutron absorbing metal hydride phase contained within (i) a ceramic matrix having a density of greater than 95% or (ii) a metal matrix having a density of greater than 99%, wherein the ceramic matrix comprises magnesium oxide, and the metal matrix comprises nickel, titanium or zirconium; and the metal hydride is a hydride of one or more of the following: gadolinium, hafnium, europium, or samarium.

In another embodiment, the disclosure provides a nuclear reactor comprising a shield for nuclear radiation, the shield comprising a composite structure that comprises a neutron-absorbing metal hydride phase contained within (i) a ceramic matrix having a density of greater than 95% or (ii) a metal matrix having a density of greater than 99%, wherein the ceramic matrix comprises magnesium oxide, and the metal matrix comprises nickel, titanium or zirconium; and the metal hydride is a hydride of one or more of the following: gadolinium, hafnium, europium, or samarium. The nuclear reactor can comprise a fission or a fusion reactor. In one practice, the shield at least partly surrounds the central core of the reactor, the core-surrounds of the reactor, or both.

### BRIEF DESCRIPTION OF THE DRAWINGS

FIG. 1 is a conceptualization of an embodiment of a neutron absorbing entrained hydride shield of the disclosure.

FIG. 2 is a graph depicting the plateau pressures of a range of metal hydrides as a function of temperature. The hydrogen density of each material is provided parenthetically. The inset to FIG. 2 is the notional metal matrix and ceramic matrix processing temperature windows that can be considered in order to retain hydrides within an acceptable stoichiometric range.

FIG. 3 is a graph depicting the hydrogen diffusivity through a range of metals.

FIG. 4 is a graph of an example of a ceramic matrix neutron absorbing embedded hydride shield wherein gadolinium hydride at a nominal 40% volume fraction has been incorporated into an magnesium oxide matrix utilizing field assisted sintering. The inset to FIG. 4 is a X-ray microtomographic image showing the distribution of hydride (dark phases) within the lighter magnesium oxide matrix.

FIG. 5 shows a comparison of conventional shield materials to exemplary entrained neutron absorbing shield composites of the disclosure, wherein the inboard magnet of a tokamak reactor is modeled with two slabs of shielding materials Shield 1 and Shield 2, stacked in the shielding gap between the first wall and inboard superconducting magnet pack. The inset numbers in FIG. 5 provide the relative magnet absorbed heating and damage energy deposited by irradiation at constant power for various combinations of Shield 1 and Shield 2 materials.

### DETAILED DESCRIPTION

The following detailed description of various embodiments of the disclosure are made without limitation to the scope of the disclosure and are made in reference to the accompanying figures. Explanation about related functions or constructions known in the art are omitted for the sake of clearness in understanding the concept of the invention to avoid obscuring the invention with unnecessary detail.

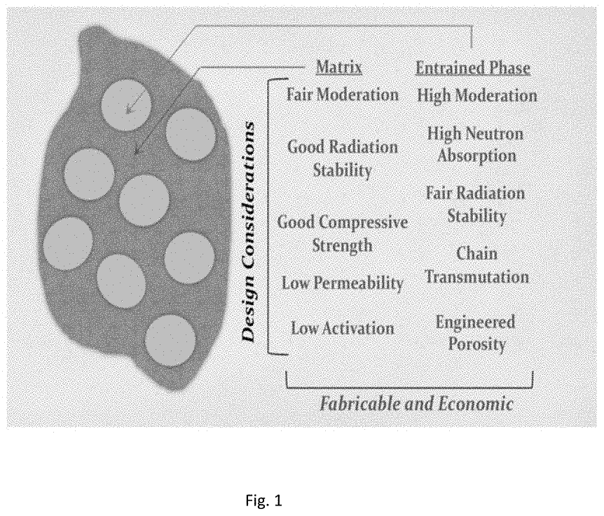

The present invention discloses a multi-component composite in which specific functions of the composite constituents are selected to interact synergistically thus providing an effective nuclear shield. Referring to FIG. 1, the schematic is a conceptual illustration of an embodiment of a neutron absorbing entrained hydride shield of the disclosure. As shown, a two-phase composite is depicted where the matrix serves a primary structural function, providing rigidity for the structure and environment stability including resistance to nuclear radiation damage: radiation stability, resistance to micro-cracking, dimensional stability. The composite has low permeability, or the ability of hydrogen to diffuse through its matrix, as hydrogen retention and high hydrogen content is a primary functional characteristic of the composite. Within this matrix is incorporated one or more entrained phases with which have the dual functions of neutron moderation and neutron absorption. Additional characteristics may be engineered into this composite including porosity within the entrained phase to incorporate any irradiation instability of that phase of release of hydrogen or other transmutation species, as known in the art. As shown in FIG. 1, a composite structure of the disclosure can be formulated from a rigid and structural matrix, potentially with a strong x-ray scattering function, which contains one or more entrained phases. Those phases have a number of functional attributes including high neutron absorption and simultaneous high neutron scattering or moderation to lower energies.

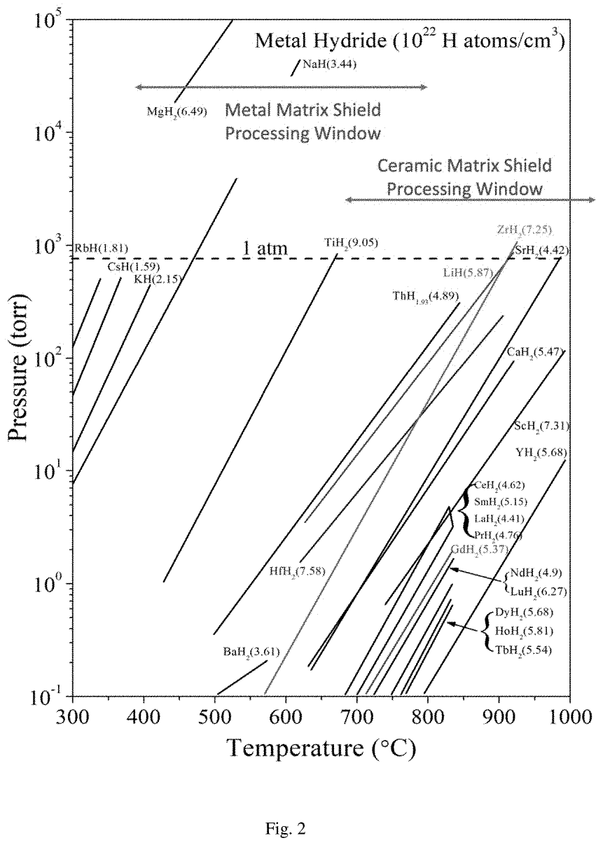

The combined functions of high neutron scattering and high neutron moderation is achieved through the incorporation of metal hydrides of high neutron absorption cross section. In one practice, the composite structure of the disclosure comprises both lower application temperature metal-matrix composites and higher temperature ceramic-matrix composites. Insofar as there is a tendency of metal hydrides towards thermal decomposition, as depicted by the plateau pressures of FIG. 2, selecting hydrides which are appropriate for the processing windows for metal and ceramic matrix composites are necessary. Referring to FIG. 2, thereat is a graph of plateau pressures of a range of metal hydrides as a function of temperature. The hydrogen density of each material is provided parenthetically. Ideal neutron moderating and absorbing shield materials are achieved through maximizing and balancing the (as processed) hydride content driving the neutron moderation with selection of neutron absorbing metal. The inset to FIG. 2 is the notional metal matrix and ceramic matrix processing temperature windows that can be considered in order to retain hydrides within an acceptable stoichiometric range.

A known neutron absorbing and shield materials utilized in the nuclear industry is natural boron or the extractive boron-10 isotope. In contrast to ¹⁰B compounds proposed for conventional shields, which are irradiation unstable and rapidly consumed, the present disclosure contemplates a range of highly-absorbing metal hydrides with high-absorption daughter products (i.e. chain absorbers such as HF: ¹⁷⁴Hf^{361b}→¹⁷⁵Hf^{892b}→¹⁷⁶Hf^{7209b}→¹⁷⁷Hf^{27b}→¹⁷⁸Hf^{521b}→¹⁷⁹Hf^{33b}, where b-barns is 10⁻²⁴ cm²). FIG. 2 provides a plot of the plateau pressures for a range of potential binary metal hydrides with their respective H densities bracketed and shows a range of binary hydrides with overlapping processing windows with for various metal matrix- and ceramic-matrix shields.

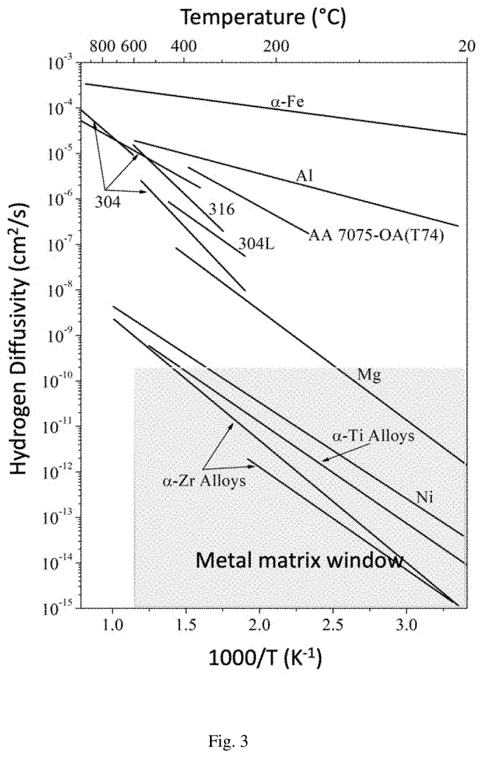

FIG. 3 provides the hydrogen diffusivity through a range of metals. A key function of the matrix is to simultaneously retain the hydrogen within the entrained phase pocket and in doing so stabilize the hydride phase from environmental decomposition, whether that environmental driver is irradiation damage or thermal decomposition. In order to achieve this stabilization, the composite matrix must itself be radiation stable and not allow hydrogen to diffuse through its body to any great extent. As the hydrogen diffusivity through magnesium oxide is very low, the potential for hydrogen diffusion through the matrix of a metal matrix neutron absorbing embedded hydride shield is potentially much higher and in many cases unacceptable. Acceptable metal matrix choices as identified by FIG. 3 include nickel, titanium and zirconium-based alloys.

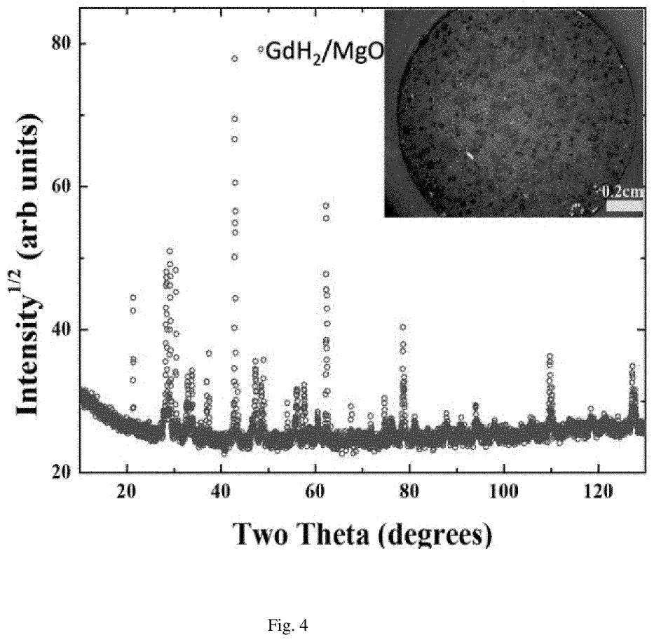

FIG. 4 shows an example of ceramic matrix neutron absorbing embedded hydride shield, specifically, a highly absorbing MgO—GdH₂ shield. In this example gadolinium hydride at a nominal 40% volume fraction has been incorporated into a magnesium oxide matrix utilizing field assisted sintering. Processing resulted in a dense magnesium oxide matrix with a retained gadolinium hydride structure as indicated by the x-ray pattern of the figure. The inset FIG. 4 a X-ray microtomographic image showing the distribution of hydride (dark phases) within the lighter magnesium oxide matrix.

In one embodiment, the composite structure comprises a neutron absorbing metal hydride phase contained within a ceramic or metal matrix each having a density of greater than 95%. In some embodiments, the matrix can have a density of greater than 96%, greater than 97%, greater than 98% and greater than 99%. The various instances, the matrix is (i) a ceramic matrix comprising a magnesium oxide or (ii) a metal matrix comprising nickel, titanium, zirconium, chromium, magnesium, or combinations thereof including alloys of the foregoing metals. In one practice, the composite structures of the present invention are substantially-free, or even devoid, of any metal halide sintering aid which is used in fabricating the composite structure. In some embodiments of the present invention, the magnesium oxide-containing matrix can have a density of greater than 96%, greater than 97%, greater than 98% and greater than 99%; and the metal matrix can have a density of greater than 99%. The metal hydride comprises a hydride of one or more of the following: Gadolinium, Hafnium, Europium, Samarium, or Hafnium. The neutron absorbing metal hydride phase is present in the matrix in an amount of about 10% volume to about 50% volume, or about 15% volume to about 40% volume. In some embodiments, the neutron absorbing metal hydride phase is distributed randomly in the matrix. In yet other embodiments, the neutron absorbing metal hydride-containing phase is distributed in an ordered manner in the matrix.

Representatively, two generic neutron absorbing embedded hydride shield composites are exemplified: ceramic matrix and metal matrix, both of which having greater than 95% dense matrix to limit hydrogen release from the entrained metal hydride phase.

### Ceramic Matrix Composite Neutron Absorbing Shield

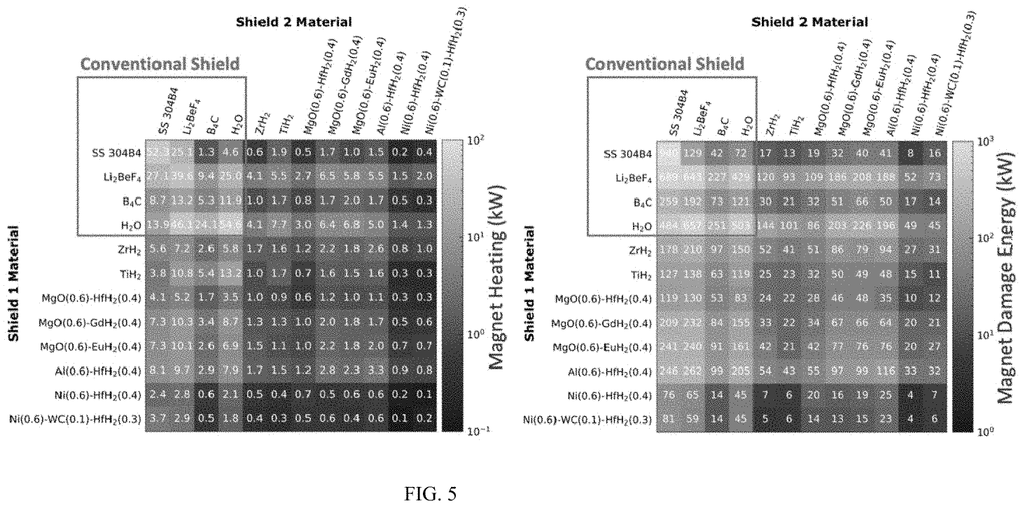

The effectiveness of the ceramic matrix composite shield comprising magnesium oxide is provided by FIG. 5, which illustrates a relative comparison of the magnet heating and magnet absorbed energy, a surrogate for radiation damage structure, for these ceramic matrix composite shield materials and conventional materials. More specifically, FIG. 5 shows a comparison of conventional shield materials to entrained neutron absorbing shield composites. In FIG. 5, the inboard magnet of a tokamak reactor is modeled with two slabs of shielding materials Shield 1 and Shield 2, stacked in the shielding gap between the first wall and inboard superconducting magnet pack. Inset numbers in FIG. 5 provide the relative magnet absorbed heating and damage energy deposited by irradiation at constant power for various combinations of Shield 1 and Shield 2 materials. By comparing combinations of conventional Shield 1 and Shield 2 materials it is possible to estimate the relative effectiveness of the neutron absorbing entrained hydride shields. In this case a number of ceramic based neutron shield materials (MgO matrix with HfH₂, GdH₂, and EuH₂) and considered as area number of metal matrices (aluminum, and nickel) with HfH₂ and tungsten carbide (WC) additions. Lower values of magnet heating and magnet damage are preferred. As seen in FIG. 5, significant reduction in heating and damage is achievable with the composite structures of the disclosure. Such a reduction can also have the practical translation of a thinner required shield.

### Metal Matrix Composite Neutron Absorbing Shield

In some embodiments of the present invention, the entrained phase that is contained within a metal matrix whereby the metal is a nickel-based alloy, a titanium-based alloy, or a zirconium-based alloy. In FIG. 5, combinations of a Ni matrix with HfH₂ and tungsten carbide (WC) additions lead to significant reductions in heating a damage relative to conventional shield materials. In other embodiments, the metal matrix can be an alloy of the aforementioned metal systems containing mixtures of these metals or the addition of other elements to serve as sintering temperature suppression aids (e.g., Mg, Al, Cr, Fe) while metal of the metal hydride-containing phase is selected from europium, gadolinium, samarium, or hafnium, and functionally graded with WC.

### EXAMPLE 1: PREPARATION SCHEME FOR CERAMIC MATRIX ENTRAINED HYDRIDE SHIELD

As derived, the simplest form of a Ceramic Matrix Entrained Hydride Shield a process with resulting near full density magnesia matrix is limited in processing temperature and time to avoid significant second phase deformation. This was achieved through manipulation of starting magnesia powder, use of a fugitive metal halide salt sintering aid, and rapid sintering through electrically-assisted sintering. To achieve required compact green density, a bimodal distribution of magnesia powder was used, ranging in near equal part 50-100 nm and 1000-5000 nm powder. Powder of >99.9% purity is optimal. Use of a single particle size is allowed, though the as-pressed green density is reduced, and the final sintered magnesia matrix density is in the range of 95-97%.

The bi-modal magnesia power was kiln-dried in an inert gas environment at 150° C. and mixed using a bladeless dual-asymmetric-centrifugal mixer. A metal halide salt of melting temperature similar to the sintering temperature as defined by the limitations of the entrained phase was selected. Appropriate salts include lithium-bromide, lithium-fluoride and lithium-chloride. One or more of these salts was included at a ratio of 1 weight percent total, or less, of salt in the bimodal-MgO/salt mixture into which entrained hydride metal or metals of up to 40 volume percent were added. The MgO/salt/entrained metal hydride dry mixture was then remixed using the dual-asymmetric-centrifugal mixer and pressed into a green-body at pressures in the range of 100-200 MPa.

Processing of ceramic matrix composite is achieved through a process of electrically-assisted sintering of mixed powders under a hydrogen environment. The specific matrix considered in this work is magnesia, or MgO, densified with the aid of and addition of lithium fluoride at a 1 volume percent addition as described elsewhere. (patent reference) A bimodal distribution of magnesia powder is effective, ranging in near equal parts 50-100 nm and 1000-5000 nm resulting in composite matrix density of >95%. Magnesia powder may also be effectively used with potentially lower but effective density, >94%. Entrained neutron hydride powder, as example gadolinium hydride, see FIG. 4, is mixed prior to cold pressing.

Electrically-assisted sintering was then carried out under vacuum (<10 Pa) on the green body in the range of 10-50 MPa with initiation of sintering beginning at somewhat less than 800° C. Moreover, as derived, a hydrogen partial pressure was utilized in the electrically-assisted sintering composites with entrained metal hydrides. Hydrogen atmosphere may be limited to the isothermal hold at maximum temperature. The hydrogen environment during sintering may be forming gas (mixture of hydrogen and an inert gas mitigating issues of hydrogen flammability) or mono-molecular hydrogen. The presence of hydrogen effectively shifts the temperature-dissociation curve of the second phase metal-hydride to higher temperature, thereby improving the processing temperature window. Compositions including mixture in the range of 20% to 30% of metal hydride content are typical. Contents may be in a continuum range up to 50% of the composite volume.

### EXAMPLE 2: PREPARATION SCHEME FOR METAL MATRIX ENTRAINED HYDRIDE COMPOSITE

As derived, the simplest form of a Metal Matrix Entrained Hydride Shield is a process with resulting near full density of the metal matrix is limited in processing temperature and time to avoid significant thermal decomposition of the entrained metal hydride. This may be achieved through the pre-alloying of the solvent powder with sintering temperature suppression aids, rapid forming, and an adequate green compact density prior to forming. Pre-alloying of the metal powders used high energy ball milling of Ni with Mg where the concentration of Mg was up to 30 wt. %. Elemental metal powders of >99.5% purity is optimal. The pre-alloyed powders may be mixed with one or more high neutron absorbing metal hydrides using a bladeless dual-asymmetric-centrifugal mixer and pressed into a green body at pressures in the range of 100-200 MPa.

As the processing temperature of the metal matrix composite (FIG. 2) spans a lower temperature regime than that of the magnesium-oxide-based composite as described as Example 1, the range of potential entrained hydrides is more comprehensive (FIG. 2) This lower processing temperature enables metal matrix composite to include less thermally stable neutron absorbing hydrides such as HfH₂ to a higher extent. Moreover, they will allow the inclusion of highly moderating hydrides such as TiH₂ and LiH. The ability incorporate and mix this broad range of neutron absorbing and moderating suite of metal hydrides allows the metal matrix composite of this example to be easily modified and optimized for a specified shield function.

Electrically-assisted sintering may be used to avoid thermal decomposition of the entrained metal hydride and carried out under vacuum (<10 Pa) and hydrogen partial pressures on the green body in the range of 10-50 MPa. The hydrogen environment during sintering may be forming gas (mixture of hydrogen and an inert gas mitigating issues of hydrogen flammability) or mono-molecular hydrogen and may be limited to the isothermal hold at maximum temperature. The presence of hydrogen effectively shifts the temperature-dissociation curve of the second phase metal-hydride to higher temperature, thereby improving the processing temperature window. Compositions including mixture in the range of 10% to 30% of metal hydride content are typical. Contents may be in a continuum range up to 60% of the composite volume.

While the present invention has been particularly shown and described with respect to preferred embodiments thereof, it will be understood by those skilled in the art that the foregoing and other changes in forms and details may be made without departing from the spirit and scope of the present invention. It is therefore intended that the present invention not be limited to the exact forms and details described and illustrated, but fall within the scope of the appended claims.

What is claimed is:

1. A composite structure comprising a neutron absorbing metal hydride phase contained within (i) a ceramic matrix having a density of greater than 95% or (ii) a metal matrix having a density of greater than 99%, wherein the ceramic matrix comprises magnesium oxide, and the metal matrix comprises nickel, titanium, zirconium, or combinations thereof; and the metal hydride is a hydride of one or more of the following: Gadolinium, Hafnium, Europium, or Samarium.

2. The composite structure of claim 1 further comprising a sintering temperature suppressing aid selected from one or more of the following alloying elements: aluminum, magnesium, chromium, and iron.

3. The composite structure of claim 1 wherein the neutron absorbing metal hydride phase is present in the ceramic matrix or metal matrix in an amount of about 10% volume to about 50% volume

4. A composite structure comprising a neutron-absorbing metal hydride phase contained within a magnesium oxide-containing matrix having a density of greater than 95%.

5. The composite structure of claim 4 wherein the metal hydride is a hydride of one or more of the following: Gadolinium, Hafnium, Europium, or Samarium.

6. A composite structure comprising a neutron-absorbing metal hydride phase contained within a nickel-based matrix having a density of greater than 99%.

7. The composite structure of claim 6 wherein the metal hydride is a hydride of one or more of the following: Gadolinium, Hafnium, Europium, or Samarium.

8. A composite structure comprising a neutron-absorbing metal hydride phase contained within a titanium-based matrix having a density of greater than 99%.

9. The composite structure of claim 8 wherein the metal hydride is a hydride of one or more of the following: Gadolinium, Hafnium, Europium, or Samarium.

10. A composite structure comprising a neutron-absorbing metal hydride phase contained within a zirconium-based matrix having a density of greater than 99%.

11. The composite structure of claim 10 wherein the metal hydride is a hydride of one or more of the following: Gadolinium, Hafnium, Europium, or Samarium.

12. A shield for nuclear radiation comprising a composite structure that comprises a neutron-absorbing metal hydride phase contained within (i) a ceramic matrix having a density of greater than 95% or (ii) a metal matrix having a density of greater than 99%, wherein the ceramic matrix comprises magnesium oxide, and the metal matrix comprises nickel, titanium, zirconium, or combinations thereof; and the metal hydride is a hydride of one or more of the following: Gadolinium, Hafnium, Europium, or Samarium.

13. The shield of claim 12 further comprising a sintering temperature suppressing aid selected from one or more of the following alloying elements: aluminum, magnesium, chromium, and iron.

14. The shield of claim 12 wherein the neutron absorbing metal hydride phase is present in the ceramic matrix or metal matrix in an amount of about 10% volume to about 50% volume

15. The shield of claim 12 wherein the nuclear radiation comprises neutrons, gamma radiation, or both.

16. A nuclear reactor fusion or fission system comprising a shield for nuclear radiation, the shield comprising a composite structure that comprises a neutron-absorbing metal hydride phase contained within (i) a ceramic matrix having a density of greater than 95% or (ii) a metal matrix having a density of greater than 99%, wherein the ceramic matrix comprises magnesium oxide, and the metal matrix comprises nickel, titanium, zirconium, or combinations thereof; and the metal hydride is a hydride of one or more of the following: Gadolinium, Hafnium, Europium, or Samarium.

17. The nuclear reactor fusion or fission system of claim 16 further comprising a sintering temperature suppressing aid selected from one or more of the following alloying elements: aluminum, magnesium, chromium, and iron.

18. The nuclear reactor fusion or fission system of claim 16 wherein the neutron absorbing metal hydride phase is present in the ceramic matrix or metal matrix in an amount of about 10% volume to about 50% volume.

19. The nuclear reactor fusion or fission system of claim 16 wherein the system comprises a fission reactor.

20. The nuclear reactor fusion or fission system of claim 16 wherein the system comprises a fusion reactor.

21. The nuclear reactor fusion or fission system of claim 16 wherein the nuclear radiation comprises neutrons, gamma radiation, or both.

22. The nuclear reactor fusion or fission system of claim 16 wherein the shield at least partly surrounds the central core of the reactor, the core-surrounds of the reactor, or both.
